(19) United States
(12) Patent Application Publication
(10) Pub. No.: US 2008/0198441 A1
(43) Pub. Date: Aug. 21, 2008

(54) COLOR SELECTIVE ACTIVE POLARIZER AND MAGNETIC DISPLAY PANEL EMPLOYING THE SAME

(75) Inventor: Sung Nae Cho, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/030,896

(22) Filed: Feb. 14, 2008

(30) Foreign Application Priority Data
Feb. 16, 2007 (KR) 10-2007-0016783
May 11, 2007 (KR) 10-2007-0046199
Aug. 10, 2007 (KR) 10-2007-0080600

(51) Int. Cl. G02F 1/09

(52) U.S. Cl. 359/281

(57) ABSTRACT

Provided are a color selective active polarizer controlled by a magnetic field and a magnetic display panel employing the color selective active polarizer. The color selective active polarizer includes a magnetic material layer structured such that magnetic particles are buried in a transparent insulating medium. Dyes or color absorbing particles are mixed in the magnetic material layer. The color selective active polarizer transmits light polarized in a first direction and reflects light polarized in a second direction when a magnetic field is applied. The light polarized in the first direction transmitted by the color selective active polarizer has colors according to the dyes or color absorbing particles.

### CROSS-REFERENCE TO RELATED PATENT APPLICATION

This application claims the benefit of Korean Patent Application No. 10-2007-0016783, filed on Feb. 16, 2007, No. 10-2007-0046199, filed on May 11, 2007, and No. 10-2007-0080600, filed on Aug. 10, 2007, in the Korean Intellectual Property Office, the disclosure of which is incorporated herein in their entireties by reference.

### BACKGROUND OF THE INVENTION

1. Field of the Invention

Apparatuses consistent with the present invention relate to a color selective active polarizer and a magnetic display panel employing the same, and more particularly, to a color selective active polarizer controlled by a magnetic field and a magnetic display panel employing the color selective active polarizer.

2. Description of the Related Art

An absorptive polarizer, which absorbs light polarized in a predetermined direction, is often used as a rear polarizer of a liquid crystal display (LCD) panel and the like. However, only half of light emitted from a backlight unit is transmitted and the remaining half is absorbed by the rear polarizer. To solve the problem, the use of a reflective polarizer instead of the absorptive polarizer has been proposed.

An example of the reflective polarizer is a wire-grid polarizer. The wire-grid polarizer includes a transparent substrate and conductive metal wires arranged at regular intervals in parallel to one another on the transparent substrate. The wire-grid polarizer reflects light having a polarization component parallel to the metal wires and transmits light having a polarization component perpendicular to the metal wires. In order for the wire-grid polarizer to function as a polarizer in visible wavelength ranges, the pitch of the metal wires should be less than about 100 nm, thereby making the manufacturing process difficult and increasing manufacturing costs. Although small wire-grid polarizers usable at visible wavelength ranges have been manufactured in laboratories, manufacturing technology for mass production of large wire-grid polarizers for visible light is yet to be developed.

### SUMMARY OF THE INVENTION

The present invention provides a large active reflective polarizer that can be mass produced at low cost.

The present invention also provides a color selective active polarizer that can function as a color filter.

The present invention also provides a magnetic display panel using the color selective active polarizer.

According to an aspect of the present invention, there is provided a color selective active polarizer comprising a magnetic material layer structured such that magnetic particles are buried in a transparent insulating medium, wherein dyes or color absorbing particles are mixed in the magnetic material layer, the color selective active polarizer transmitting light polarized in a first direction and reflecting light polarized in a second direction when an magnetic field is applied, the light polarized in the first direction transmitted by the color selective active polarizer having colors according to the dyes or color absorbing particles.

The color selective active polarizer may reflect all light when the magnetic field is removed.

The magnetic material layer may have a thickness greater than the magnetic decay length of the magnetic material layer.

The magnetic material layer may be structured such that core-shell type magnetic particles and color absorbing particles are mixed and distributed in one medium.

Each of the core-shell type magnetic particles may include a magnetic core formed of a magnetic material and an insulating shell surrounding the magnetic core.

The insulating shell may be formed of a transparent insulating material surrounding the magnetic core.

The insulating shell may be formed of a polymer-type transparent insulating surfactant surrounding the magnetic core.

One magnetic core may form a single magnetic domain.

The magnetic material used for the magnetic core may be any one selected from the group consisting of cobalt, iron, iron oxide, nickel, cobalt-platinum (Co—Pt), iron-platinum (Fe—Pt), titanium, aluminum, barium, platinum, sodium, strontium, magnesium, dysprosium, manganese, gadolinium, silver, copper, and chromium, or an alloy thereof.

The number n of magnetic cores needed along the path of light that travels through the magnetic material layer in the thickness direction of the magnetic material layer may be given by

n≧s/d,

where s is the magnetic decay length of the magnetic cores at the wavelength of incident light and d is the diameter of the magnetic cores.

The size of the color absorbing particles may be less than or equal to the size of the magnetic particles.

Each of the color absorbing particles may include a core formed of a dielectric material and a shell formed of a metal.

The color absorbing particles distributed in the magnetic material layer may have different color-to-shell ratios.

The magnetic material layer may be formed by immersing a mixture of core-shell type magnetic particles with the dyes in a solution and coating and curing the resultant product on a transparent substrate.

The color selective active polarizer may further comprise a magnetic field applying unit applying a magnetic field to the magnetic material layer, wherein the magnetic field applying unit includes a plurality of wires arranged in parallel to one another around the magnetic material layer and a power source supplying current to the wires.

The wires may be arranged to surround the magnetic material layer.

The wires may be arranged on either a top surface or a bottom surface of the magnetic material layer.

The wires may be formed of any one selected from the group consisting of indium tin oxide (ITO), aluminum, copper, silver, platinum, gold, and iodine-doped polyacetylene.

The color selective active polarizer may further comprise a magnetic field applying unit applying a magnetic field to the magnetic material layer, wherein the magnetic field applying unit includes a transparent plate electrode disposed on a surface of the magnetic material layer and a power source supplying current to the transparent plate electrode.

The transparent plate electrode may be formed of ITO or a conductive metal having a thickness less than the skin depth length of the transparent plate electrode.

According to another aspect of the present invention, there is provided a magnetic display pixel comprising: a magnetic material layer transmitting light when an magnetic field is applied and blocking light when no magnetic field is applied; a first electrode disposed on a bottom surface of the magnetic material layer; a second electrode disposed on a top surface of the magnetic material layer; and a spacer disposed on a side surface of the magnetic material layer and electrically connecting the first electrode and the second electrode, wherein dyes or color absorbing particles are mixed in the magnetic material layer.

The magnetic display pixel may further comprise a first transparent substrate disposed on the first electrode and a second transparent substrate disposed on the second electrode.

The magnetic material layer may transmit light polarized in a first direction and reflect light polarized in a second direction perpendicular to the first direction when an magnetic field is applied, and reflect all light when no magnetic field is applied.

The magnetic material layer may be structured such that magnetic particles are buried without aggregation in a transparent insulating medium.

The magnetic material layer may have a thickness greater than the magnetic decay length of the magnetic material layer.

The magnetic material layer may be structured such that core-shell type magnetic particles and color absorbing particles are mixed and distributed in one medium.

Each of the core-shell type magnetic particles may include a magnetic core formed of a magnetic material and an insulating shell surrounding the magnetic core.

The insulating shell may be formed of a transparent insulating material surrounding the magnetic core.

The insulating shell may be formed of a polymer type transparent insulating surfactant surrounding the magnetic core.

One magnetic core may form a single magnetic domain.

The magnetic material used for the magnetic core may be any one selected from the group consisting of cobalt, iron, iron oxide, nickel, Co—Pt, Fe—Pt, titanium, aluminum, barium, platinum, sodium, strontium, magnesium, dysprosium, manganese, gadolinium, silver, copper, and chromium, or an alloy thereof.

The number n of magnetic cores needed along the path of light that travels through the magnetic material layer in the thickness direction of the magnetic material layer may be given by

n≧s/d,

where s is the magnetic decay length of the magnetic cores at the wavelength of incident light and d is the diameter of the magnetic cores.

The size of the color absorbing particles may be less than or equal to the size of the magnetic particles.

Each of the color absorbing particles may include a core formed of a dielectric material and a shell formed of a metal.

Color absorbing particles having different core-to-shell ratios may be distributed in the magnetic material layer.

The magnetic material layer may be formed by immersing a mixture of core-shell type magnetic particles with the dyes in a solution and coating and curing the resultant product on a transparent substrate.

The magnetic display pixel may further comprise anti-reflection coating formed on at least one of optical surfaces ranging from the magnetic material layer to an outer surface of the second transparent substrate.

The magnetic display pixel may further comprise an absorptive polarizer disposed on any one of optical surfaces ranging from the magnetic material layer to an outer surface of the second transparent substrate.

The magnetic display pixel may further comprise a mirror or a semi-transmissive mirror formed on at least one of optical surfaces ranging from the magnetic material layer to an outer surface of the first transparent substrate.

Each of the first electrode, the second electrode, and the conductive spacer may be formed of one selected from the group consisting of aluminum, copper, silver, platinum, gold, and iodine-doped polyacetylene.

A plurality of first holes may be formed in the first electrode so that light can pass through the first electrode, wherein a plurality of wires extending in a direction in which current flows are formed between the first holes.

Light transmissive materials may be formed in the first holes between the wires.

A second hole may be formed in the second electrode facing the second electrode so that light can pass through the second electrode.

A light transmissive material may be formed in the second hole of the second electrode.

The second electrode may be of a mesh or grid wire type electrically connected to the conductive spacer.

Each of the first electrode and the second electrode may be formed of a transparent conductive material.

The magnetic display pixel may further comprise a control circuit disposed on a side surface of the magnetic material layer and switching the flow of current between the first electrode and the second electrode.

The magnetic display pixel may further comprise a black matrix disposed on a surface of the second electrode to face the control circuit and the conductive spacer.

According to another aspect of the present invention, there is provided a magnetic display panel comprising a plurality of magnetic display pixels each constructed as described above.

The magnetic display panel may be a flexible display panel, wherein each of the first transparent substrate, the second transparent substrate, the first electrode, and the second electrode is formed of a flexible material.

Each of the first transparent substrate and the second transparent substrate may be formed of a light transmissive resin material, and each of the first electrode and the second electrode may be formed of a conductive polymer material.

The magnetic display panel may further comprise an organic thin film transistor (TFT) disposed on a side surface of the magnetic material layer between the first transparent substrate and the second transparent substrate and switching the flow of current between the first electrode and the second electrode.

The magnetic display panel may further comprise a display unit in which a plurality of pixels are arranged, and a separate controller unit individually switching the flow of current between the first electrode and the second electrode for pixels.

A plurality of pixels may share one first transparent substrate, second transparent substrate, and second electrode, and one magnetic material layer and one first electrode applying a magnetic field to the magnetic material layer may be disposed per pixel.

According to another aspect of the present invention, there is provided a double-sided display panel comprising: a backlight unit; and first and second magnetic display panels disposed on both surfaces of the backlight unit in a symmetric manner and each comprising a plurality of magnetic display pixels each constructed as described above.

According to another aspect of the present invention, there is provided an electronic device employing a magnetic display panel comprising a plurality of magnetic display pixels each constructed as described above.

### BRIEF DESCRIPTION OF THE DRAWINGS

The above and other features of the present invention will become more apparent by describing in detail exemplary embodiments thereof with reference to the attached drawings in which:

FIG. 1 is a perspective view illustrating the structure of a color selective active polarizer according to an exemplary embodiment of the present invention;

FIG. 2 is a cross-sectional view of the color selective active polarizer of FIG. 1;

FIG. 3 illustrates the core-shell structure of a magnetic particle used in the color selective active polarizer of FIG. 1;

FIG. 4 is a perspective view illustrating the operation of the color selective active polarizer of FIG. 1 when the color selective active polarizer is in an off state;

FIG. 5 is a perspective view illustrating the operation of the color selective active polarizer of FIG. 1 when the color selective active polarizer is in an on state;

FIGS. 6 and 7 are graphs illustrating the intensity of a magnetic field in the color selective active polarizer of FIG. 1;

FIGS. 8 and 9 are graphs illustrating the ratio of the transmittance of light parallel to the color selective active polarizer of FIG. 1 to the transmittance of light perpendicular to the color selective active polarizer of FIG. 1;

FIG. 10 is a cross-sectional view illustrating the structure of a sub-pixel of a magnetic display panel according to an exemplary embodiment of the present invention;

FIG. 11 is a perspective view illustrating the structures of a sub-pixel electrode, a conductive spacer, and a common electrode of the sub-pixel of the magnetic display panel of FIG. 10;

FIG. 12A illustrates magnetic fields formed around wires of the sub-pixel of FIG. 10;

FIG. 12B is a cross-sectional view illustrating the structures of the sub-pixel electrode, a magnetic material layer, and the common electrode taken along line A-A′ of FIG. 1;

FIG. 13 is a perspective view illustrating the arrangement of sub-pixels and the structure of a common electrode in a magnetic display panel according to an exemplary embodiment of the present invention;

FIG. 14 is a perspective view illustrating the arrangement of sub-pixels and the structure of a common electrode in a magnetic display panel according to another exemplary embodiment of the present invention;

FIG. 15 is a perspective view illustrating the arrangement of sub-pixels and the structure of a common electrode in a magnetic display panel according to another exemplary embodiment of the present invention;

FIG. 16 is a perspective view illustrating the arrangement of sub-pixels and the structure of a common electrode in a magnetic display panel according to another exemplary embodiment of the present invention;

FIG. 17 is a cross-sectional view illustrating the operation of the sub-pixel of the magnetic display panel of FIG. 10 when the sub-pixel is in an off state;

FIG. 18 is a cross-sectional view illustrating the operation of the sub-pixel of the magnetic display panel of FIG. 10 when the sub-pixel is in an on state;

FIG. 19 is a cross-sectional view illustrating the structures of sub-pixels of a double-sided display panel using the sub-pixel of the magnetic display panel of FIG. 10 according to an exemplary embodiment of the present invention;

FIG. 20 is a cross-sectional view illustrating the operations of the sub-pixels of the double-sided display panel of FIG. 19;

FIG. 21 is a cross-sectional view illustrating the structure of a sub-pixel of a magnetic display panel according to another exemplary embodiment of the present invention; and

FIG. 22 is a conceptual view illustrating a connection structure between a controller unit and a display unit.

### DETAILED DESCRIPTION OF THE INVENTION

The present invention will now be described more fully with reference to the accompanying drawings, in which exemplary embodiments of the invention are shown.

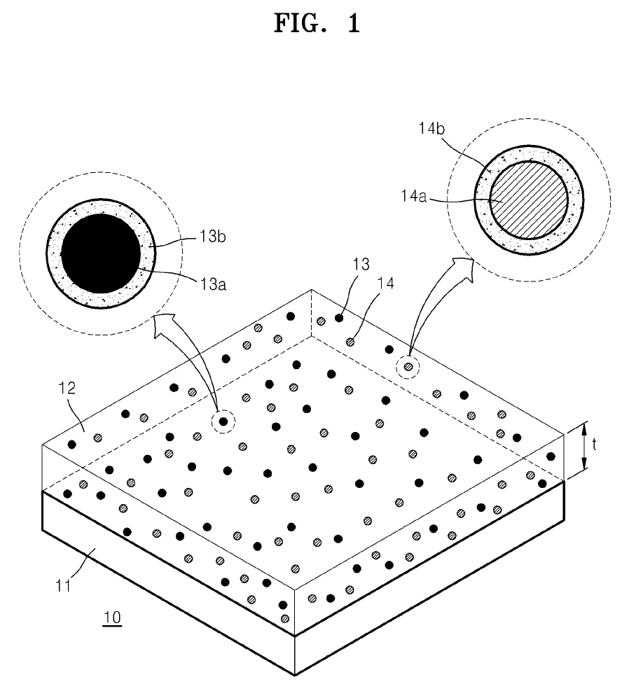

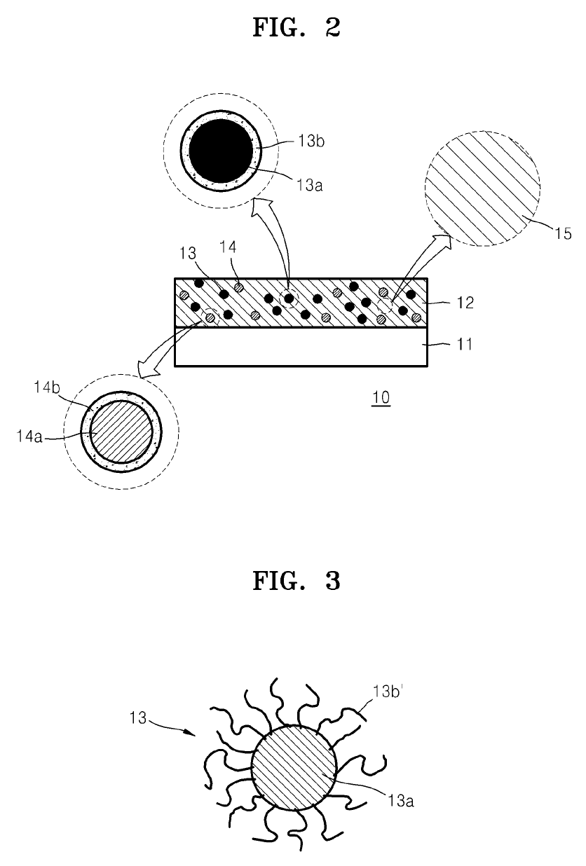

FIG. 1 is a perspective view illustrating the structure of a color selective active polarizer 10 according to an exemplary embodiment of the present invention. FIG. 2 is a cross-sectional view of the color selective active polarizer 10 of FIG. 1. Referring to FIGS. 1 and 2, the color selective active polarizer 10 includes a transparent substrate 11, and a magnetic material layer 12 formed on the transparent substrate 11. The magnetic material layer 12 may be formed such that a plurality of magnetic particles 13 and a plurality of color absorbing particles 14 are buried in one transparent insulating medium 15. In FIGS. 1 and 2, the magnetic particles 13 and the color absorbing particles 14 are depicted as being sparsely distributed in the magnetic material layer 12 for simplicity in illustration. In an exemplary embodiment, the magnetic particles 13 and the color absorbing particles 14, however, are actually very densely distributed in the magnetic material layer 12.

The magnetic particles 13 each including a magnetic core may be buried in the transparent insulating medium 15 without aggregating or electrically contacting one another. As enlarged and shown in FIGS. 1 and 2, in order to prevent the magnetic particles 13 from aggregating or electrically contacting one another, each of the magnetic particles 13 may include a magnetic core 13a and a transparent, non-magnetic, insulating shell 13b surrounding the magnetic core 13a. Also, a transparent, insulating, dielectric material like the insulating shell 13b may be filled in regions between the magnetic particles 13.

The core 13a of the magnetic particles 13 may be formed of any material that has magnetic properties. For example, the core 13a of the magnetic particles 13 may be formed of a ferromagnetic or superparamagnetic metal, such as cobalt, iron, nickel, cobalt-platinum (Co—Pt), or iron-platinum (Fe—Pt), or an alloy thereof. Alternatively, the core 13a of the magnetic particles 13 may be formed of a paramagnetic metal, such as titanium, aluminum, barium, platinum, sodium, strontium, magnesium, dysprosium, manganese, or gadolinium, or an alloy thereof. Alternatively, the core 13a of the magnetic particles 13 may be formed of a diamagnetic metal, such as silver or copper, or an alloy thereof. Alternatively, the core 13a, of the magnetic particles 13 may be formed of an antiferromagnetic metal, such as chromium, which changes to a paramagnetic material at a temperature above the Neel temperature. Instead of a metal, the core 13a of the magnetic particles 13 may be formed of a dielectric material, a semiconductor, or a polymer which has magnetic properties. The core 13a of the magnetic particles 13 may be formed of a ferromagnetic substance having low conductivity and high magnetic susceptibility, such as an iron oxide or Sr₈CaRe₃Cu₄O₂₄. The iron oxide may be MnZn(Fe₂O₄)₂, MnFe₂O₄, Fe₃O₄, or Fe₂O₃.

The diameter of the core 13a should be small enough to form a single magnetic domain using one core 13a. Accordingly, the diameter of the core 13a of the magnetic particles 13 may range from several nanometers (nm) to tens of nanometers (nm) according to a material in use. For example, the diameter of the core 13a may range from approximately 1 to 200 nm according to a material in use.

The shells 13b prevent the cores 13a of the magnetic particles 13 from aggregating or directly contacting one another as described above, thereby avoiding conduction between the cores 13a. To this end, each shell 13b formed of a transparent non-magnetic insulating dielectric material, such as silicate (SiO₂) or zirconium-oxide (ZrO₂), may surround the core 13a. FIG. 3 illustrates the core-shell structure of a magnetic particle used in the color selective active polarizer of FIG. 1. Referring to FIG. 3, a shell 13b′ formed of a polymer type surfactant may surround the core 13a. The polymer type surfactant should be transparent and have insulating and non-magnetic properties. The shell 13b or 13b′ may have a sufficient thickness to prevent electrically conducting adjacent cores 13a of the magnetic particles 13.

The color absorbing particles 14 may have core-shell structures as enlarged and shown in FIGS. 1 and 2. However, there is a difference in that the core-shell structures of the magnetic particles 13 include a core 13a formed of a metal and a shell 13b formed of a dielectric material whereas the core-shell structures of the color absorbing particles 14 include a core 14a formed of a dielectric material and a shell 14b formed of a metal. For example, the shell 14b of the color absorbing particles 14 may be formed of gold, silver, or aluminum, and the core 14a of the color absorbing particles 14 may be formed of SiO₂. The core-shell type color absorbing particles 14 are widely used for filters absorbing light in a specific wavelength band. If light is incident on a thin metal layer formed on a dielectric substance, a surface plasmon resonance arises at an interface between the dielectric substance and the metal layer to absorb light in a predetermined wavelength band. The resonance wavelength is not related to the size of a core-shell structure but is determined by the ratio of the diameter of a core to the diameter of a shell. However, in order to generate a surface plasmon resonance, it is preferable that the diameter of the color absorbing particles 14 be less than approximately 50 nm.

While the same kind of color absorbing particles 14 are distributed in the magnetic material layer 12 in FIGS. 1 and 2, various kinds of color absorbing particles 14 may be mixed and distributed in the magnetic material layer 12. For example, green light may be obtained by mixing and distributing a color absorbing particle absorbing light of a red wavelength and a color absorbing particle absorbing light of a blue wavelength in the magnetic material layer 12. Red light may be obtained by mixing and distributing a color absorbing particle absorbing light of a green wavelength and a color absorbing particle absorbing light of a blue wavelength in the magnetic material layer 12. Accordingly, the core-to-shell ratios of the color absorbing particles 14 distributed in the magnetic material layer 12 may be different from one another.

The color absorbing particles 14 do not have to have spherical shapes, and may have nanorod shapes. The color absorbing particles 14 having nanorod shapes may absorb light in a predetermined wavelength band due to a surface plasmon resonance. In this case, the resonance wavelength is determined by the aspect ratio of the nanorod shapes. Accordingly, color absorbing particles 14 having nanorod shapes whose aspect ratios are different and color absorbing particles 14 having spherical shapes whose core-to-shell ratios are different may be mixed and distributed in the magnetic material layer 12.

The magnetic material layer 12 may be formed by immersing the core-shell type magnetic particles 13 and color absorbing particles 14 in one solution and spin coating or deep coating and curing the resultant product on the transparent substrate 11. The magnetic material layer 12 may be formed in other ways as long as the magnetic particles 13 can be prevented from aggregating or electrically contacting one another. The size of the color absorbing particles 14 may be less than or equal to the size of the magnetic particles 13. If the size of the color absorbing particles 14 is greater than the size of the magnetic particles 13, polarization separation performed by the magnetic particles 13 may be degraded.

The reason why the color absorbing particles 14 are distributed in the magnetic material layer 12 is to enable the magnetic material layer 12 to function as a color filter. Accordingly, the magnetic material layer 12 may be configured in different ways as long as the magnetic material layer 12 can function as a color filter without affecting the function of the magnetic particles 13. For example, the magnetic material layer 12 may be formed by distributing and curing the core-shell type magnetic particles 13 in a liquid or paste medium for a color filter. Alternatively, the magnetic material layer 12 may be formed by immersing a mixture of the core-shell type magnetic particles 13 with dyes for a color filter in a solution and spin coating and curing the resultant product on the transparent substrate 11.

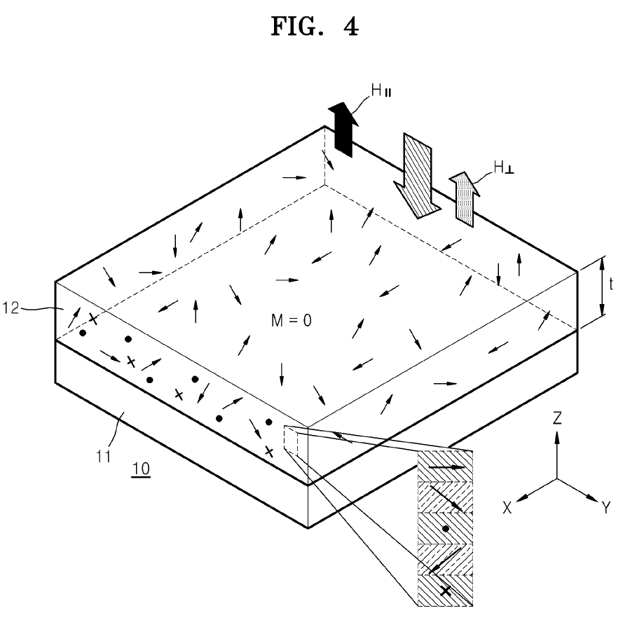

FIG. 4 illustrates the orientations of magnetic moments in the magnetic material layer 12 when an magnetic field is not applied. When no magnetic field is applied, all the magnetic moments in the magnetic material layer 12 are randomly oriented as shown by arrows in FIG. 4. In FIG. 4, ‘’ indicates magnetic moments in a +x direction and ‘×’ indicates magnetic moments in a x direction. Also, as enlarged and shown in FIG. 4, the magnetic moments in the magnetic material layer 22 are randomly oriented in a vertical direction, that is, in a z direction, as well as in horizontal directions, that is, in x and y directions. Accordingly, when an magnetic field is not applied, total magnetization in the magnetic material layer 12 is zero (M=0).

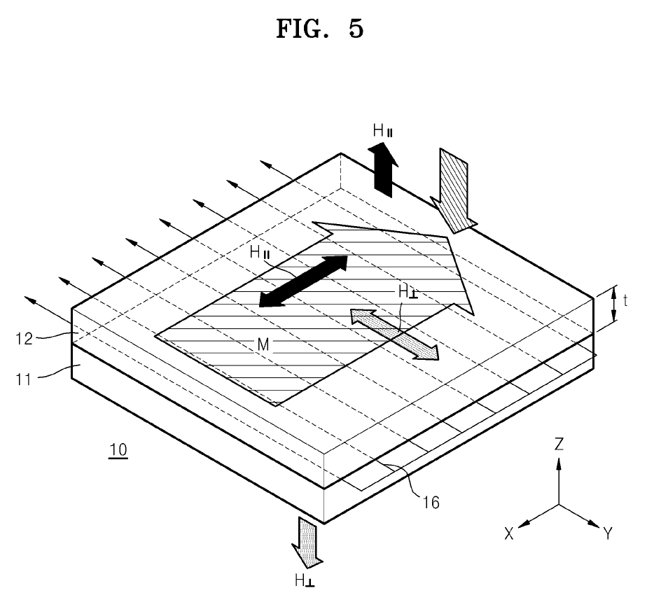

FIG. 5 is a perspective view illustrating the operation of the color selective active polarizer of FIG. 1 when an magnetic field is applied around the magnetic material layer 12. As a magnetic field applying unit for applying a magnetic field around the magnetic material layer 12, a plurality of wires 16 may be arranged around the magnetic material layer 12. The wires 16 may be formed of a transparent conductive material such as indium tin oxide (ITO). However, when a distance between the wires 16 is much greater than the width of the wires 16, the wires 16 may be formed of an opaque metal with low resistance such as aluminum, copper, silver, platinum, gold, barium, chromium, sodium, strontium, or magnesium. Alternatively, the wires 16 may be formed of a conductive polymer such as iodine-doped polyacetylene. While the wires 16 are disposed on a bottom surface of the magnetic material layer 12 in FIG. 5, the wires 16 may be disposed on a top surface of the magnetic material layer 12 or may surround the magnetic material layer 12.

Although not shown, a plate electrode formed of a transparent conductive material, such as ITO, instead of the wires 16, may be formed as a magnetic field applying unit on the entire surface of the magnetic material layer 12. A technology allowing a metal to be thinly coated to a thickness less than several nanometers (nm) has recently been developed. When a conductive metal is formed to a thickness less than the skin depth of the conductive metal, light can be transmitted through the conductive metal. Accordingly, a plate electrode may be formed by coating a conductive metal to a thickness less than the skin depth of the conductive metal on the entire surface of the magnetic material layer 12.

Once a magnetic field is applied around the magnetic material layer 12 using the magnetic field applying unit, the magnetic moments in the magnetic material layer 12 are arranged in one direction along the magnetic field. For example, as shown in FIG. 5, when current flows in a y direction along the wires 16, the magnetic moments in the magnetic material layer 12 are oriented in a x direction, such that the magnetic material layer 12 is magnetized in the x direction.

The operation of the magnetic material layer 12 constructed as described above will now be explained.

The magnetic field of an electromagnetic wave incident on the magnetic material layer 12 may be decomposed into a component H⊥ perpendicular to the magnetization direction of the magnetic material layer 12 and a component H_{∥} parallel to the magnetization direction of the magnetic material layer 12. When the component H_{∥} parallel to the magnetization direction of the magnetic material layer 12 is incident on the magnetic material layer 12, the component H_{∥} interacts with the magnetic moments oriented in the magnetization direction and results in induced magnetic moments. The induced magnetic moments are time varying according to the amplitude of the component H_{∥}. According to the electromagnetic radiation theory, the time-varying induced magnetic moments produce electromagnetic waves. The generated electromagnetic waves propagate in all directions. However, electromagnetic waves traveling through the magnetic material layer 12, that is, traveling in a z direction, suffer from attenuation losses. When the thickness t of the magnetic material layer 12 is greater than a magnetic decay length, which is analogous to a skin depth length for an electric field, among the electromagnetic waves generated by the induced magnetic moments, most of the electromagnetic waves traveling through the magnetic material layer 12 decay and only electromagnetic waves traveling in a +z direction are left. Accordingly, the component H_{∥} parallel to the magnetization direction of the magnetic material layer 12 may be thought to be reflected by the magnetic material layer 12.

On the other hand, when the component H⊥ perpendicular to the magnetization direction of the magnetic material layer 12 is incident on the magnetic material layer 12, the component H⊥ perpendicular to the magnetization direction of the magnetic material layer 12 does not interact with the magnetic moments and thus does not produce any induced magnetic moments. As a result, the component H⊥ perpendicular to the magnetization direction of the magnetic material layer 12 passes through the magnetic material layer 12 without any attenuation.

Hence, among the components of the magnetic field of the electromagnetic wave incident on the magnetic material layer 12, the component H_{∥}|parallel to the magnetization direction of the magnetic material layer 12 is reflected by the magnetic material layer 12, whereas the component H⊥ perpendicular to the magnetization direction of the magnetic material layer 12 is transmitted through the magnetic material layer 12. Accordingly, light energy S_{∥}=E_{∥}×H_{∥} related to the component H_{∥} parallel to the magnetization direction is reflected by the magnetic material layer 12, and light energy S_{∥}=E_{∥}×H_{∥} related to the component H_{∥} perpendicular to the magnetization direction is transmitted through the magnetic material layer 12.

When no magnetic field is applied to the magnetic material layer 12 as shown in FIG. 4, the magnetic moments in the magnetic material layer 12 are randomly oriented in the depth direction, that is, the z direction, as well as in the x and y directions. Accordingly, when no magnetic field is applied, all light incident on the magnetic material layer 12 is reflected by the magnetic material layer 12. However, an magnetic field is applied to the magnetic material layer 12 as shown in FIG. 5, the magnetic moments in the magnetic material layer 12 are arranged in one direction. Accordingly, among light incident on the magnetic material layer 12, light having a polarization component parallel to the magnetization direction is reflected by the magnetic material layer 12, and light having a polarization component perpendicular to the magnetization direction is transmitted through the magnetic material layer 12. In this regard, the magnetic material layer 12 acts as a mirror when no magnetic field is applied, and acts as a reflective polarizer when an magnetic field is applied. In particular, light transmitted through the magnetic material layer 12 has specific colors according to dyes or the color absorbing particles 14 included in the magnetic material layer 12. In other words, the light transmitted by the magnetic material layer 12 would include a color that is not absorbed by the dyes or the color absorbing particles 14.

In order to enable the magnetic material layer 12 to perform polarization separation well, the magnetic material layer 12 should have a thickness great enough to sufficiently attenuate electromagnetic waves traveling through the magnetic material layer 12. That is, the thickness of the magnetic material layer 12 should be greater than the magnetic decay length of the magnetic material layer 12 as described above. In particular, when the magnetic particles 13 include magnetic cores dispersed in a medium, a sufficient number of magnetic cores should exist along the path of light traveling through the magnetic material layer 12. For example, when it is assumed that the magnetic material layer 12 is structured such that magnetic cores are uniformly distributed over a monolayer on an x-y plane and a plurality of identical monolayers are stacked in a z direction, the number n of the magnetic cores 13a needed along the path of light traveling in a z direction is given by

n≧s/d EQN. (1)

where s is the magnetic decay length of the magnetic cores 13a at the wavelength of incident light and d is the diameter of the magnetic cores 13a. For example, when the magnetic cores 13a has a magnetic decay length of 35 nm at the wavelength of incident light, at least 5 magnetic cores are required along an optical path. Accordingly, when the magnetic material layer 12 includes a plurality of magnetic cores dispersed in a medium, the thickness of the magnetic material layer 12 may be determined so that n or more magnetic cores can exist in the thickness direction of the magnetic material layer 12.

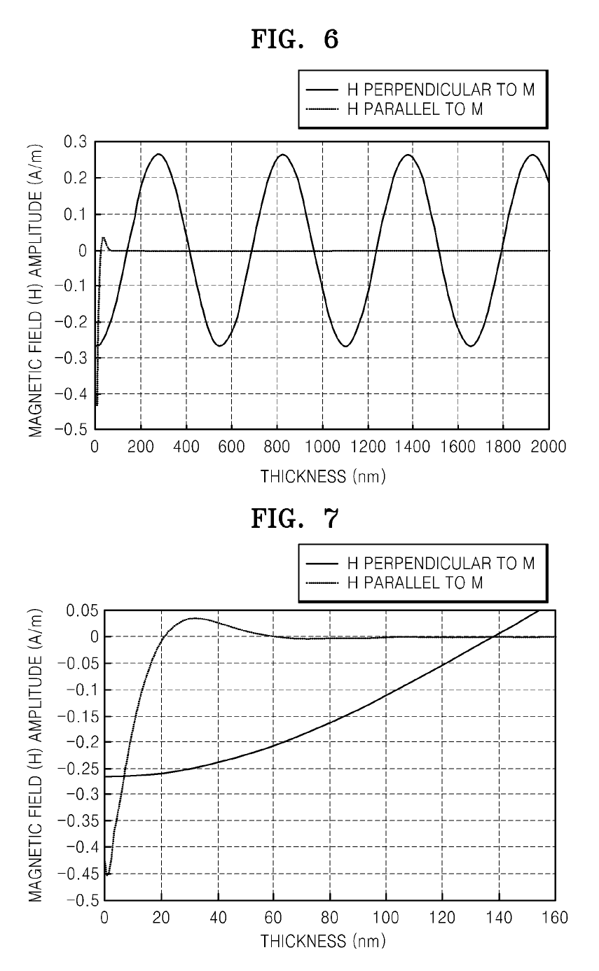

FIGS. 6 through 9 are graphs illustrating the results of simulations performed to confirm the characteristics of the color selective active polarizer 10 of FIG. 1 according to exemplary embodiments of the present invention.

FIG. 6 is a graph illustrating a relationship between the intensity (A/m) of a magnetic field time-varying while passing through the color selective active polarizer 10 when an magnetic field is applied. FIG. 7 is a graph showing an enlarged portion of FIG. 6. FIGS. 6 and 7 illustrate the results of calculation when titanium was used as the magnetic material of the magnetic material layer 12 and the wavelength of incident light was 550 nm. It is known that titanium has a magnetic susceptibility of approximately 18×10⁻⁵ at a room temperature of 20° C. and an electrical conductivity of approximately 2.38×10⁶S where S denotes siemens. Referring to FIGS. 6 and 7, a magnetic field perpendicular to the magnetization direction of the magnetic material layer 12 is transmitted through the magnetic material layer 12 without an attenuation loss even when the thickness of the magnetic material layer 12 increases. In contrast, a magnetic field parallel to the magnetization direction of the magnetic material layer 12 is drastically attenuated with an amplitude of nearly 0 at about 60 nm. Accordingly, when the magnetic material layer 22 is formed of titanium, it is preferable that the thickness of the magnetic material layer 12 be greater than approximately 60 nm.

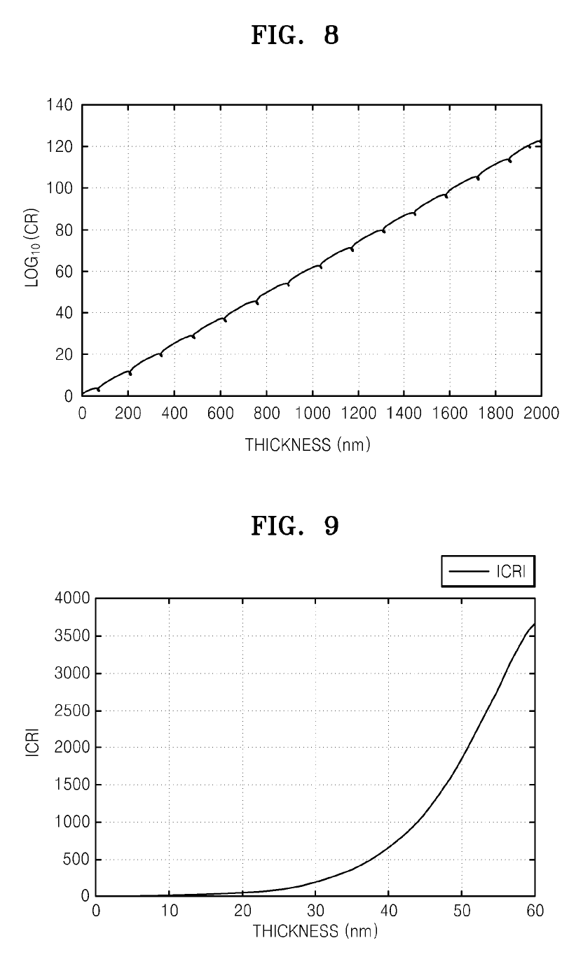

FIG. 8 is a graph illustrating the log₁₀ CR of a contrast ratio CR. Contrast ratio CR is the ratio of the transmittance of light with a magnetic field perpendicular to the magnetization direction of the color selective active reflective polarizer 10 to the transmittance of light with a magnetic field parallel to the magnetization direction of the color selective active reflective polarizer 10. FIG. 9 is a graph illustrating the absolute value of the CR. For example, when “W1” is light desired to be transmitted and “W2” is light not desired to be transmitted, a contrast ratio CR may be defined as W1/W2. For the color selective active reflective polarizer 10, “W1” is S⊥=E⊥×H⊥ and “W2” is S_{∥}=E_{∥}×H_{∥}. Referring to FIGS. 8 and 9, as the thickness of the magnetic material layer 12 increases, the contrast ratio CR increases considerably. For example, the contrast ratio CR is greater than approximately 3500:1 when the thickness of the magnetic material layer 12 is approximately 60 nm. Accordingly, a very high contrast ratio CR can be obtained even when the magnetic material layer 12 has a very low thickness.

The color selective active polarizer 10 can be more easily manufactured at lower costs than conventional wire-grid polarizers. Furthermore, the color selective active polarizer 10 can be manufactured in large sizes. Also, since the color selective active polarizer 10 can serve as a color filter as well as a reflective polarizer, the color selective active polarizer 10 can be applied to various display devices. In particular, when a ferromagnetic material, such as cobalt, iron, nickel, Co—Pt, or Fe—Pt, is used as the material for the magnetic material layer 12, the arrangement of the magnetic moments is not changed by a magnetic field applied to the magnetic material layer 12, thereby reducing power consumption.

Since the color selective active polarizer 10 blocks all light when no magnetic field is applied thereto and transmits light when an magnetic field is applied thereto, the color selective active polarizer 10 can be used as an optical shutter as well. In other words, the magnetic material layer 12 is switchable between partly transmitting incident light or reflecting all of the incident light depending on whether the magnetic field is applied. Accordingly, a pixel of a display panel can be manufactured using the principle of the magnetic material layer 12 of the color selective active polarizer 10.

The structure and operation of a magnetic display panel according to an exemplary embodiment of the present invention will now be explained in detail.

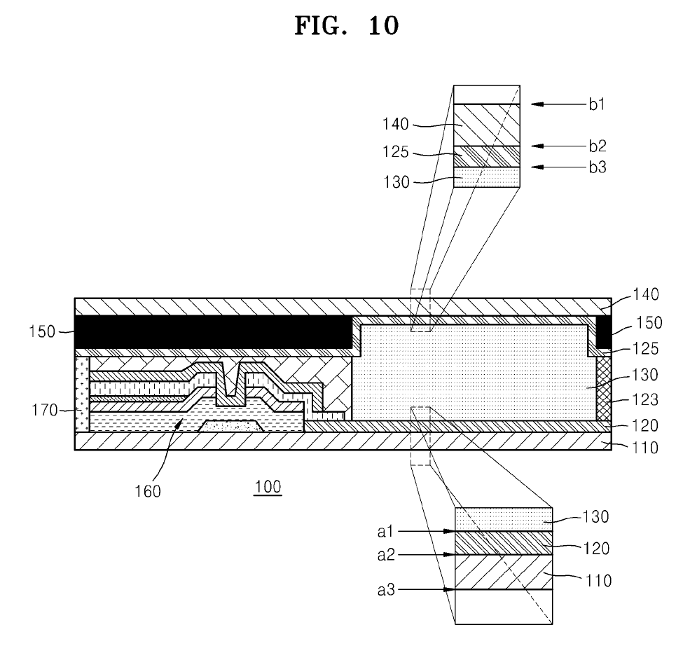

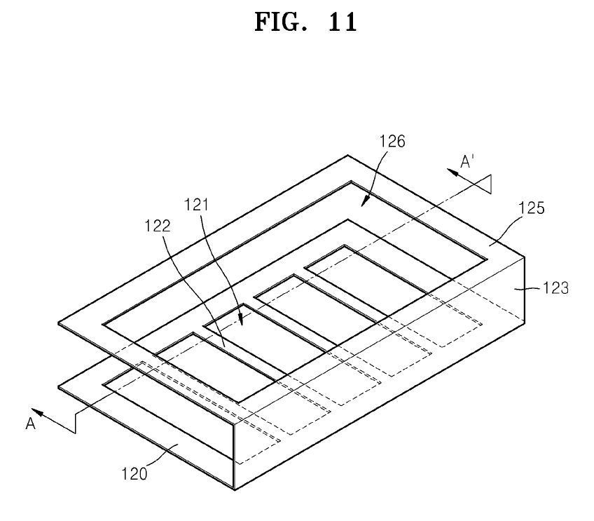

FIG. 10 is a cross-sectional view illustrating the structure of a sub-pixel 100 of a magnetic display panel according to an exemplary embodiment of the present invention. Referring to FIG. 10, one sub-pixel 100 of the magnetic display panel includes first and second transparent substrates 110 and 140 facing each other, a magnetic material layer 130 filled between the first and second transparent substrates 110 and 140, a sub-pixel electrode 120 partially formed on an inner surface of the first transparent substrate 110, a common electrode 125 disposed on an inner surface of the second transparent substrate 140, and a conductive spacer 123 disposed on a side surface of the magnetic material layer 130 and adapted to seal the magnetic material layer 130 and electrically connect the sub-pixel electrode 120 and the common electrode 125. All pixels 100 of the magnetic display panel may share one first transparent substrate 110, second transparent substrate 140, and common electrode 125.

The magnetic material layer 130 of FIG. 10 has the same structure as that of the magnetic material layer 12 of the color selective active polarizer 10 of FIG. 1. That is, the magnetic material layer 130 may be structured such that a plurality of magnetic particles and a plurality of color absorbing particles are buried in one transparent insulating medium. The magnetic material layer 130 may be formed by mixing core-shell type magnetic particles with dyes for a color filter. However, in order for a ferromagnetic material to be used as the material for cores of the magnetic particles, in the magnetic material layer 130 of the sub-pixel 100 of the magnetic display panel of FIG. 10, the ferromagnetic material may be in superparamagnetic state because the arrangement of the ferrormagnetic material is not changed once the magnetic particles are arranged in one direction. However, the ferromagnetic material behaves like a paramagnetic material in a superparamagnetic region. In order to transform the ferromagnetic material to a superparamagnetic material, the volume of the cores should be less than the volume of a single magnetic domain.

Accordingly, the cores of the magnetic particles of the magnetic material layer 130 of the sub-pixel 100 of the magnetic display panel may be formed of a paramagnetic metal, such as titanium, aluminum, barium, platinum, sodium, strontium, magnesium, dysprosium, manganese, or gadolinium, or an alloy thereof, a diamagnetic metal, such as silver or copper, or an alloy thereof, or an antiferromagnetic metal, such as chromium. Alternatively, the cores of the magnetic particle of the magnetic material layer 130 may be formed of a material obtained by transforming a ferromagnetic material, such as cobalt, iron, nickel, Co—Pt, or Fe—Pt into a upperparamagnetic material; an iron oxide, such as MnZn(Fe₂O₄)₂, MnFe₂O₄, or Fe₃O₄, Fe₂O₃; or a ferrimagnetic material, such as Sr₈CaRe₃Cu₄O₂₄.

A control circuit 160 may be disposed between the first and second transparent substrates 110 and 140 adjacent to the magnetic material layer 130 to switch the flow of current between the sub-pixel electrode 120 and the common electrode 125. For example, the control circuit 160 may be a thin film transistor (TFT) that is typically used in a liquid crystal display (LCD) panel. In this case, when a voltage is applied to a gate electrode of the TFT, the TFT is turned on and current begins to flow between the sub-pixel electrode 120 and the common electrode 125.

A vertical barrier rib 170 is formed between the common electrode 125 and the first transparent substrate 110 along an edge of the sub-pixel 100. The barrier rib 170 cooperates with the conductive spacer 123 to completely seal an inner space between the first and second transparent substrates 110 and 140.

A black matrix 150 is formed between the second transparent substrate 140 and the common electrode 125 to face the control circuit 160, the barrier rib 170, and the conductive spacer 123. The black matrix 150 covers the control circuit 160, the barrier rib 170, and the conductive spacer 123 such that the control circuit 160, the barrier rib 170 and the conductive spacer 123 are prevented from being exposed to the outside.

Although not shown in FIG. 10, in order to prevent dazzling of eyes due to reflection or diffusion of external light, an anti-reflection coating may be formed on at least one of optical surfaces from the magnetic material layer 130 to a top surface of the second transparent substrate 140. For example, referring to an upper enlarged figure of FIG. 10, an anti-reflection coating may be formed on at least one of a surface b3 between the magnetic material layer 130 and the common electrode 125, a surface b2 between the common electrode 125 and the second transparent substrate 140, and a top surface b1 of the second transparent substrate 140. Also, in order to properly reuse external light passing through the magnetic material layer 130, a mirror or a semi-transmissive mirror may be formed on at least one of optical surfaces ranging from the magnetic material layer 130 to a bottom surface of the first transparent substrate 110. For example, referring to a lower enlarged figure of FIG. 10, a mirror or a semi-transmissive mirror may be formed on at least one of a surface a1 between the magnetic material layer 130 and the sub-pixel electrode 120, a surface a2 between the sub-pixel electrode 120 and the first transparent substrate 110, and a bottom surface a3 of the first transparent substrate 110. When a mirror is formed on the entire surface, the sub-pixel 100 of the magnetic display panel can use only external light to display an image. When a mirror or a semi-transmissive mirror is partially formed on the surface, both external light and light emitted from a backlight unit can be used to display an image.

FIG. 11 is a perspective view illustrating the structures of the sub-pixel electrode 120, the conductive spacer 123, and the common electrode 125 of the sub-pixel 100 of the magnetic display panel of FIG. 10. Referring to FIG. 11, the sub pixel electrode 120 faces a bottom surface of the magnetic material layer 130, the common electrode 125 faces a top surface of the magnetic material layer 130, and the conductive spacer 123 is disposed on a side of the magnetic material layer 130 to electrically connect the sub-pixel electrode 120 and the common electrode 125.

Each of the sub-pixel electrode 120, the conductive spacer 123, and the common electrode 125, may be formed of an opaque metal with low resistance, such as aluminum (Al), copper (Cu), silver (Ag), platinum (Pt), gold (Au), barium (Ba), chromium (Cr), sodium (Na), strontium (Sr), or magnesium (Mg); or a conductive polymer, such as iodine-doped polyacetylene.

When an opaque material is used, in order for light to pass through the sub-pixel electrode 120 and the common electrode 125, holes 121 and 126 are formed in the sub-pixel electrode 120 and the common electrode 125 such that the sub-pixel electrode 120 and the common electrode 125 communicate with the magnetic material layer 130 as shown in FIG. 11. In order to easily apply a magnetic field to the magnetic material layer 130, a plurality of small holes 121 are formed in parallel to one another in the sub-pixel electrode 120, such that a plurality of wires 122 extending in a direction in which current flows can be disposed between the holes 121. One large hole 126 having almost the same size as the magnetic material layer 130 may be formed in the common electrode 125.

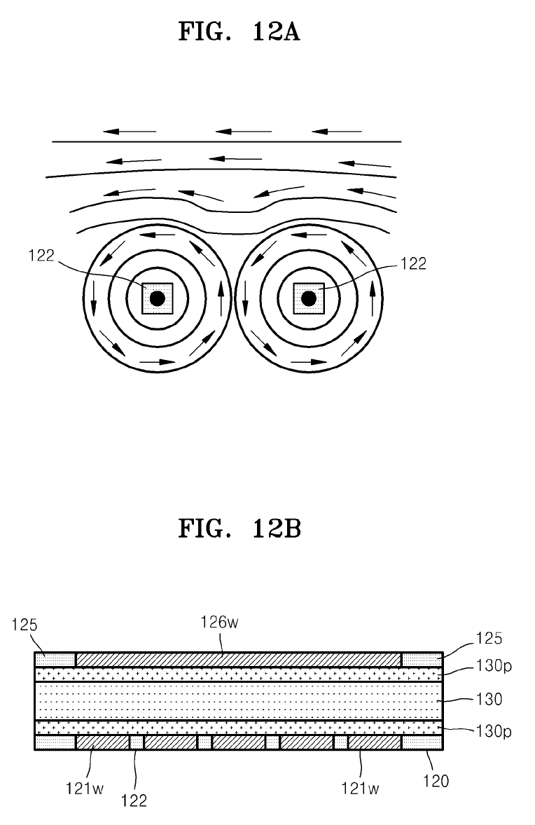

FIG. 12A illustrates magnetic fields formed around the wires 122 when current is supplied to the wires 122. Referring to FIG. 12A, magnetic fields are offset and do not exist between the wires 122, and become parallel as they are farther away from the wires 122. Accordingly, it is preferable that the magnetic material layer 130 should not smear into spaces between the wires 122. Also, the magnetic material layer 130 may be spaced by a predetermined distance from the wires 122.

FIG. 12B is a cross-sectional view taken along line A-A′ of FIG. 11, illustrating the structures of the sub-pixel electrode 120, the magnetic material layer 130, and the common electrode 125. Referring to FIG. 12B, light transmissive materials 121w and 126w may be respectively filled in the holes 121 formed between the wires 122 of the sub-pixel electrode 120 and the hole 126 of the common electrode 125. Also, light transmissive materials 130p each having a predetermined thickness may be interposed between the sub-pixel electrode 120 and the magnetic material layer 130 and between the common electrode 125 and the magnetic material layer 130. Accordingly, uniform magnetic fields can be applied to the entire magnetic material layer 130, and the magnetic material layer 130 can be prevented from smearing into the holes 121 between the wires 122 where magnetic fields are either zero or very small.

However, the sub-pixel electrode 120 and the common electrode 125 may be formed of a conductive material that is transparent to visible light, such as ITO. In this case, there is no need to form holes in the sub-pixel electrode 120 and the common electrode 125. Also, a technology allowing a metal to be thinly coated to a thickness less than several nanometers (nm) has recently been developed. When a conductive metal is formed to a thickness less than the skin depth of the conductive metal, light can be transmitted through the conductive metal. Accordingly, the sub-pixel electrode 120 and the common electrode 125 may be formed by coating a conductive metal to a thickness less than the skin depth of the metal.

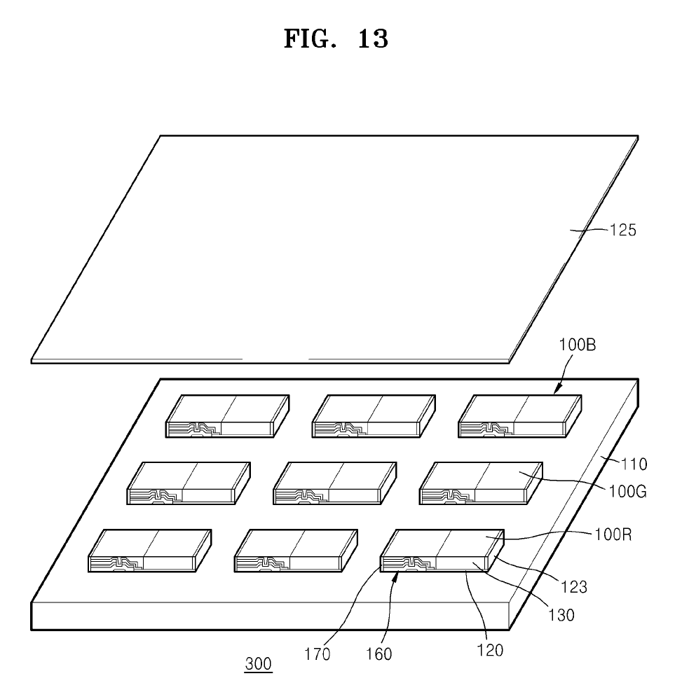

FIGS. 13 through 15 are perspective views illustrating the various structures of an array of sub-pixels 100 and a common electrode 125 shared by the array of sub-pixels 100 in a magnetic display panel 300 according to exemplary embodiments of the present invention.

Referring to FIG. 13, the magnetic display panel 300 may include an array of sub-pixels 100 arranged in two dimensions on one common first transparent substrate 110. Sub-pixels having different colors may form one pixel. For example, referring to FIG. 13, a sub-pixel 100R having a red color, a sub-pixel 100G having a green color, and a sub-pixel 100B having a blue color may form one pixel. As described above, the colors of the sub-pixels 100R, 100G, and 100B may be determined by dyes or color absorbing particles mixed in a magnetic material layer.

Also, the array of sub-pixels 100 of the magnetic display panel 300 share one common electrode 125. Referring to FIG. 13, the common electrode 125 is a transparent electrode formed of a transparent conductive material. In this case, there is no need to form a hole, through which light passes, in the common electrode 125. In this structure, only when a control circuit 160 disposed in each of the sub-pixels 100 is turned on, current flows to a sub-pixel electrode 120 of the corresponding sub-pixel through a conductive spacer 123 from the common electrode 125. At this time, since current flows over a wide area in the common electrode 125 whereas current flows over a narrow area in the sub-pixel electrode 120, current density in the sub-pixel electrode 120 is much greater than current density in the common electrode 125. Accordingly, the magnetic material layer 130 is affected by only the sub-pixel electrode 120, and hardly affected by the common electrode 125.

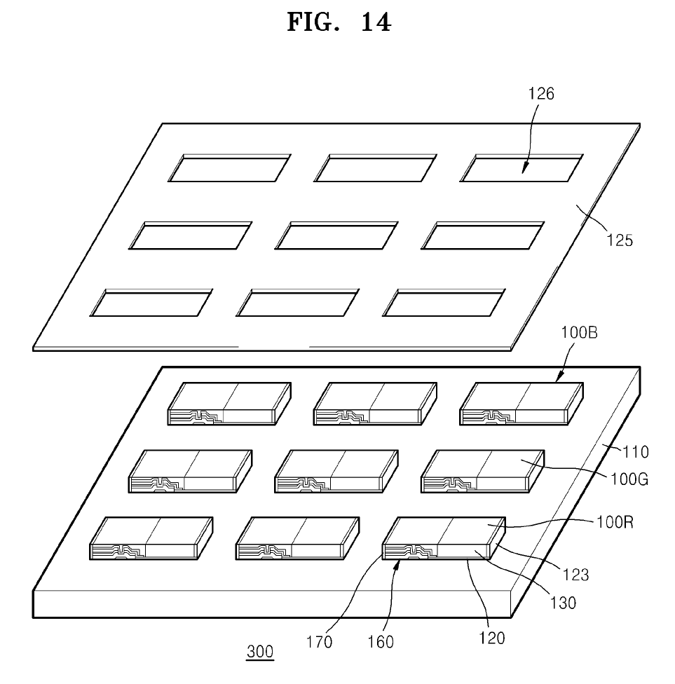

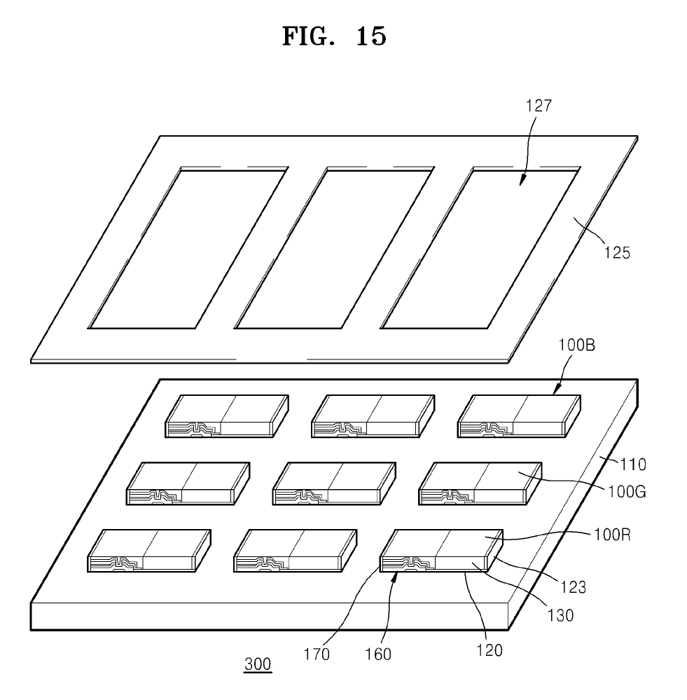

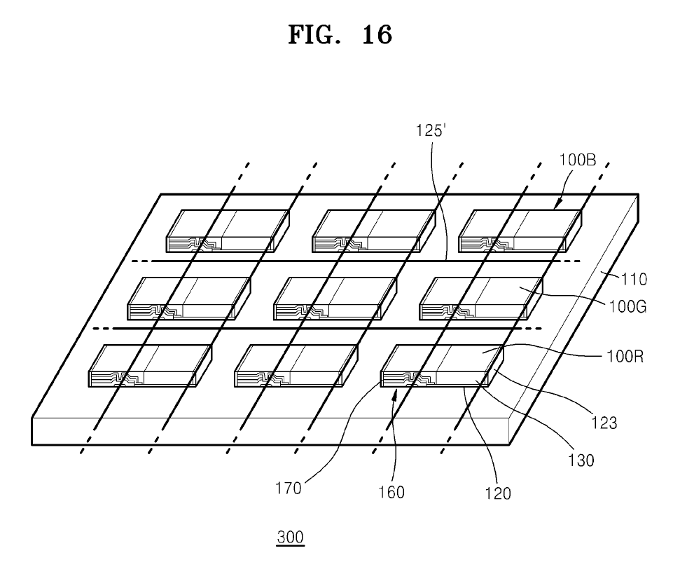

Referring to FIGS. 14 and 15, the common electrode 125 is formed of an opaque metal or a conductive polymer. In FIG. 14, holes 126 which allow light to pass therethrough are formed in the common electrode 125 to respectively correspond to the sub-pixels 100 as shown in FIG. 11. In FIG. 15, holes 127 which are larger than the holes 126 and allow light to pass therethrough are formed in the common electrode 125 to respectively correspond to pixels each composed of three sub-pixels. The structure of the common electrode 125 is not limited to the exemplary embodiments of FIGS. 13 through 15. Although it is shown in FIGS. 13 through 15 that the common electrode 125 is a plate electrode, the common electrode 125 may be of a mesh or grid wire type. FIG. 16 shows a common electrode 125′ having a mesh or a lattice structure. Regardless of its shape, the common electrode 125 should be electrically connected to the conductive spacer 123 of each of the sub-pixels. Also, although it is shown in FIGS. 13 through 15 that the common electrode 125 and the sub-pixel electrode 120 are formed on different substrates, the common electrode 125 and the sub-pixel electrode 120 may be formed on the same substrate.

The operation of one sub-pixel 100 of a magnetic display panel according to an exemplary embodiment of the present invention will now be explained in detail.

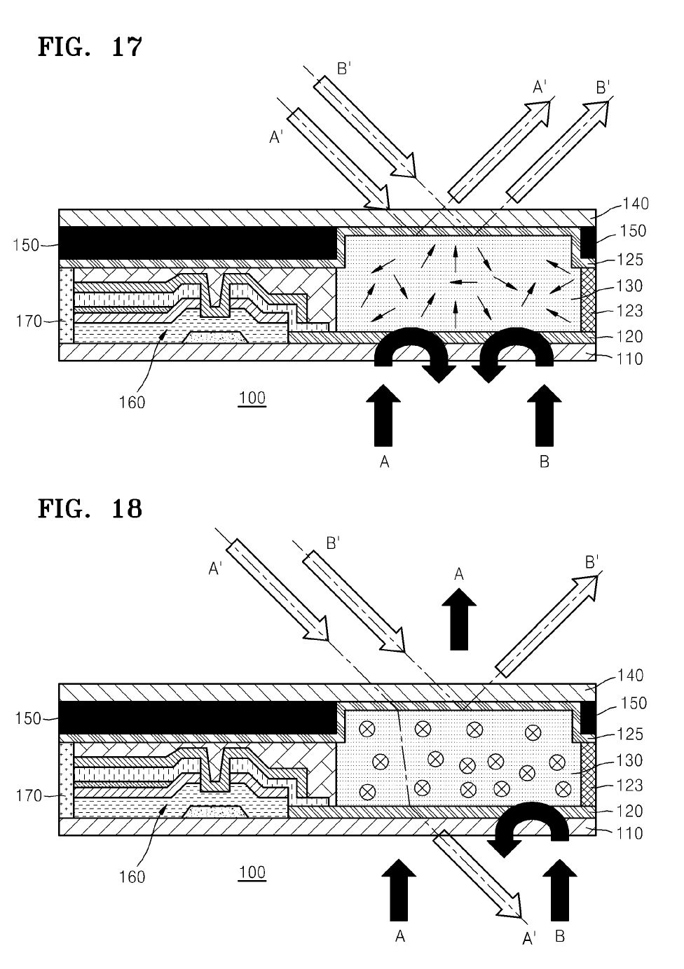

FIG. 17 is a cross-sectional view illustrating the operation of one sub-pixel 100 of the magnetic display panel of FIG. 10 when the control circuit 160 is in an off state and thus no current flows through the sub-pixel electrode 120. In this case, since no magnetic field is applied to the magnetic material layer 130, the magnetic moments in the magnetic material layer 130 are randomly oriented. Accordingly, all light incident on the magnetic material layer 130 is reflected as described above. Referring to FIG. 17, light A and B incident on the magnetic material layer 130 through the first transparent substrate 110 from a backlight unit (not shown) is reflected by the magnetic material layer 130. Also, external light A′ and B′ incident on the magnetic material layer 130 through the second transparent substrate 140 is also reflected by the magnetic material layer 130.

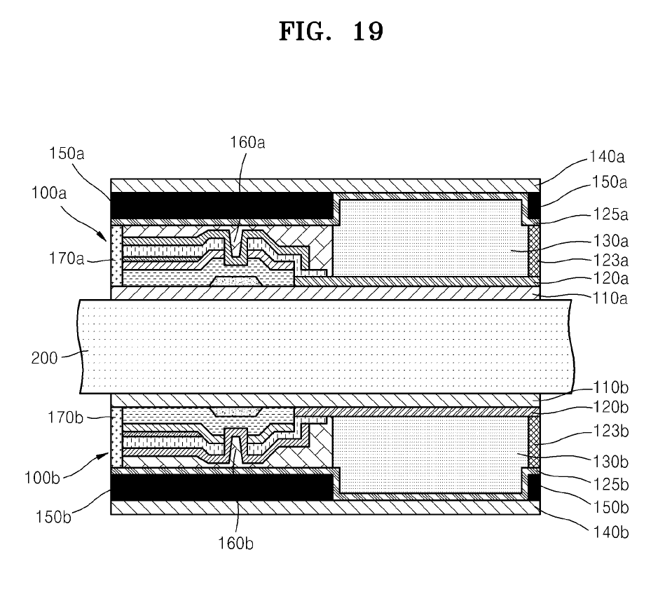

FIG. 18 is a cross-sectional view illustrating the operation of the sub-pixel 100 of the magnetic display panel of FIG. 10 when the control circuit 160 is in on state and thus current flows in the sub-pixel electrode 120. In this case, since an magnetic field is applied to the magnetic material layer 130 through the sub-pixel electrode 120, all the magnetic moments in the magnetic material layer 130 are oriented in one direction. Accordingly, light with a polarization component parallel to the magnetization direction, that is, light with a parallel polarization component, is reflected by the magnetic material layer 130, and light with a polarization component perpendicular to the magnetization direction, that is, light with a perpendicular polarization component, is transmitted through the magnetic material layer 130 as described above.

For example, as shown in FIG. 18, among light incident on the magnetic material layer 130 through the first transparent substrate 110 from the backlight unit, light A with a perpendicular polarization component passes through the magnetic material layer 130 and contributes to the formation of an image, while light B with a parallel polarization component is reflected by the magnetic material layer 130. The reflected light with the parallel polarization component may by reflected by a mirror (not shown) disposed under the backlight unit, and then converted into unpolarized light by a diffusion plate (not shown) or the like. Through this process, the reflected light with the parallel polarization component can be reused. Light emitted to the outside through the second transparent substrate 140 has colors according to dyes or color absorbing particles in the magnetic material layer 130. Accordingly, the sub-pixel 100 of the magnetic display panel can realize color light without a color filter.

Among external light incident on the magnetic material layer 130 through the second transparent substrate 140, light A′ with a perpendicular polarization component directly passes through the magnetic material layer 130. At this time, when a semi-transmissive mirror is formed on at least one of the optical surfaces ranging from the magnetic material layer 130 to the first transparent substrate 110 as described above with reference to FIG. 10, the external light A′ with the perpendicular polarization component may be reflected again and used to form an image. However, light B′ with a parallel polarization component incident on the magnetic material layer 130 through the second transparent substrate 140 is reflected by the surface of the magnetic material layer 130. The reflected light B′ does not contribute to the formation of an image and may cause eyestrain. Accordingly, an absorptive polarizer may be disposed on at least one of the optical surfaces ranging from the magnetic material layer to the second transparent substrate 140 to absorb only the light B′ with the parallel polarization component. Also, an anti-reflection coating may be formed on at least one of the optical surfaces ranging from the magnetic material layer 130 to the second transparent substrate 140 as described above with reference to FIG. 10.

FIG. 19 is a cross-sectional view illustrating the structures of sub-pixels 100a and 100b of a double-sided display panel using the sub-pixel 100 of the magnetic display panel of FIG. 10 according to an exemplary embodiment of the present invention. In FIG. 19, only the two facing sub-pixels 100a and 100b are shown for convenience. Referring to FIG. 19, the sub-pixel 100a of a first magnetic display panel and the sub-pixel 100b of a second magnetic display panel are disposed on both surfaces of a backlight unit 200 in a symmetric manner. The structure of each of the sub-pixels 100a and 100b of the first and second magnetic display panels is completely identical to the structure of the sub-pixel 100 of the magnetic display panel of FIG. 10. The sub-pixels 100a and 100b of the first and second magnetic display panels include: first transparent substrates 110a and 110b and second transparent substrates 140a and 140b facing each other; magnetic material layers 130a and 130b filled between the first transparent substrates 110 and 110b and the second transparent substrates 140a and 140b; sub-pixel electrodes 120a and 120b partially formed on inner surfaces of the first transparent substrates 110a and 110b; common electrodes 125a and 125b disposed on inner surfaces of the second transparent substrates 140a and 140b; conductive spacers 123a and 123b disposed on side surfaces of the magnetic material layers 130a and 130b and adapted to seal the magnetic material layers 130a and 130b and electrically connect the sub-pixel electrodes 120a and 120b and the common electrodes 125a and 125b; and black matrices 150a and 150b disposed between the second transparent substrates 140a and 140b and the common electrodes 125a and 125b to face control circuits 160a and 160b, barrier ribs 170a and 170b, and the conductive spacers 123a and 123b. The sub-pixels 100a and 100b of the first and second magnetic display panels disposed on both the surfaces of the backlight unit 200 can be individually turned on and off.

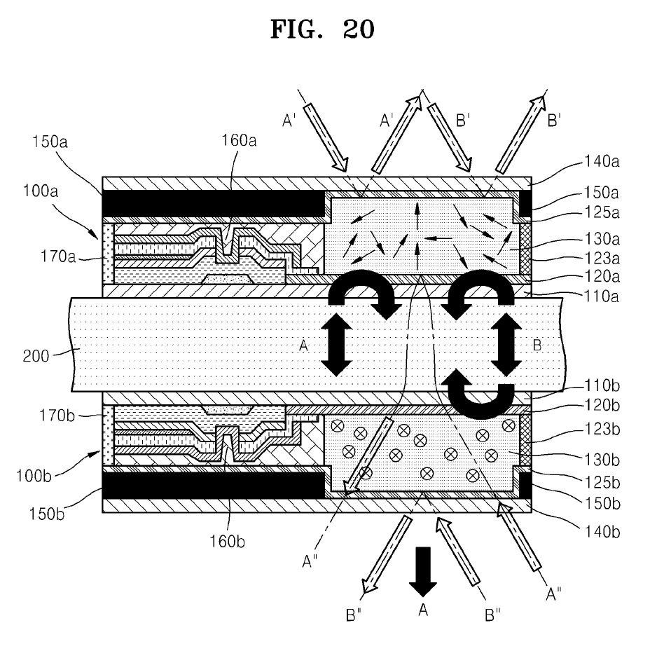

FIG. 20 is a cross-sectional view illustrating the operations of the sub-pixels 100a and 100b of the double-sided display panel of FIG. 19. In FIG. 20, the sub-pixel 100a of the first magnetic display panel is in an off state and the sub-pixel 100b of the second magnetic display panel is in an on state. In this case, since the sub-pixel 100a of the first magnetic display panel is in the off state, all light A and B and light A′ and B′ incident on the magnetic material layer 130a of the sub-pixel 100a of the first magnetic display panel from the backlight unit 200 is reflected by the magnetic material layer 130a.

However, since the sub-pixel 100b of the second magnetic display panel is in the on state, among light incident on the magnetic material layer 130b through the first transparent substrate 110b from the backlight unit 200, light A with a perpendicular polarization component passes through the magnetic material layer 130b and contributes to the formation of an image of the sub-pixel 100b of the second magnetic display panel. Light B with a parallel polarization component is reflected by the magnetic material layer 130b of the sub-pixel 100b of the second magnetic display panel. The light B with the parallel polarization component reflected by the magnetic material layer 130a of the first magnetic display panel may be incident again on the magnetic material layer 130b of the sub-pixel 100b of the second magnetic display panel. Accordingly, when a diffusion plate is disposed in the backlight unit 200, the reflected light B with the parallel polarization component can be reused as unpolarized light.

On the other hand, among external light incident on the magnetic material layer 130b through the second transparent substrate 140b of the sub-pixel 100b of the second magnetic display panel, light A″ with a perpendicular polarization component directly passes through the magnetic material layer 130b. Thereafter, the light A″ with the perpendicular polarization component is reflected by the magnetic material layer 130a of the sub-pixel 100b of the first magnetic material layer and is incident again on the magnetic material layer 130b of the sub-pixel 100b of the second magnetic display panel. The incident light A″ with the perpendicular polarization component passes through the magnetic material layer 130b, and thus contributes to the formation of an image of the sub-pixel 100b of the second magnetic display panel. Also, even when a semi-transmissive mirror is formed on at least one of optical surfaces ranging from the magnetic material layer 130b of the sub-pixel 100b of the second magnetic display panel to the first transparent substrate 110b, the same effect can be achieved. In this case, part of the light A″ with the perpendicular polarization component passing through the magnetic material layer 130b is reflected by the semi-transmissive mirror, and the remaining part of the light A″ with the perpendicular polarization component passing through the magnetic material layer 130b is reflected by the magnetic material layer 130a of the sub-pixel 100a of the first magnetic display panel. External light B″ with a parallel polarization component may be reflected by the magnetic material layer 130b of the sub-pixel 100b of the second magnetic display panel. Accordingly, as described above, an anti-reflection coating (not shown) or an absorptive polarizer (not shown) for absorbing only the external light B″ with the parallel polarization component may be formed on at least one of the optical surfaces ranging from the magnetic material layer 130b of the sub-pixel 100b of the second magnetic display panel to the second transparent substrate 150b of the sub-pixel 100b of the second magnetic display panel.

Although not shown, when both the sub-pixel 100a of the first magnetic display panel and the sub-pixel 100b of the second magnetic display panel are in on states, among light emitted by the backlight unit 200, light A with a perpendicular polarization component passes through both the magnetic material layers 130a and 130b of the sub-pixels 100a and 100b of the first and second magnetic display panels and thus contributes to the formation of an image of the sub-pixels 100a and 100b of the first and second magnetic display panels. Also, external light A′ with a perpendicular polarization component incident on the magnetic material layer 130a through the second transparent substrate 140a of the sub-pixel 100a of the first magnetic display panel directly passes through the magnetic material layer 130a. Thereafter, part of the external light A′ with the perpendicular polarization component passes through the magnetic material layer 130b of the sub-pixel 100b of the second magnetic display panel, and thus contributes to the formation of an image of the sub-pixel 100b of the second magnetic display panel. The remaining part of the external light A′ with the perpendicular polarization component is reflected by the semi-transmissive mirror, which is formed on at least one of the optical surfaces ranging from the magnetic material layer 130a of the sub-pixel 100a of the first magnetic display panel to the first transparent substrate 110a of the sub-pixel 100a of the first magnetic display panel, and thus contributes to the formation of an image of the sub-pixel 100a of the first magnetic display panel. Likewise, external light A″ with a perpendicular polarization component incident on the magnetic material layer 130b through the second transparent substrate 140b of the sub-pixel 100b of the second magnetic display panel directly passes through the magnetic material layer 130b. Thereafter, part of the external light A″ with the perpendicular polarization component passes through the magnetic material layer 130a of the sub-pixel 100a of the first magnetic display panel, and thus contributes to the formation of an image of the sub-pixel 100a of the first magnetic display panel. The remaining part of the external part A″ with the perpendicular polarization component is reflected by the semi-transmissive mirror, which is formed on at least one of the optical surfaces ranging from the magnetic material layer 130b of the sub-pixel 100b of the second magnetic display panel to the surface of the first transparent substrate 110b of the sub-pixel 100b of the second magnetic display panel, and thus contributes to the formation of an image of the sub-pixel 100b of the second magnetic display panel.

The magnetic display panel according to the present invention can be used not only as a non-flexible flat panel display panel but also as a flexible display panel. Since conventional LCD panels are manufactured at a high temperature, the conventional LCD panel are difficult use a flexible substrate which is weak to high temperature. However, since the magnetic material layer 130, which is the essential element of the magnetic display panel according to the present invention, can be manufactured at a low temperature of approximately 130 degrees, the magnetic display panel according to the present invention can be used as a flexible display panel.

In order to use the magnetic display panel according to the present invention as a flexible display panel, all the elements should be formed of a flexible material. For example, referring to FIG. 10, the first and second transparent substrates 110 and 140 may be formed of a light transmissive resin material such as polyethylene naphthalate (PEN), polycarbonate (PC), or polyethylene terephthalate (PET). Also, the sub-pixel electrode 120 and the common electrode 125 may be formed of a conductive polymer material such as iodine-doped polyacetylene. Since iodine-doped polyacetylene has very high conductivity like silver but is opaque, conventional LCD panels have not used iodine-doped polyacetylene. However, the sub-pixel electrode 120 and the common electrode 125 do not have to be transparent as described above. Also, the control circuit may be a well-known organic TFT, which is often used in a conventional flexible organic electroluminescent (EL) display or an organic light emitting diode (OLED) display. The mirror or semi-transmissive mirror formed on at least one of the optical surfaces ranging from the magnetic material layer 130 to the first transparent substrate 110 may be a dielectric mirror, not a metal mirror.

When the backlight unit is an edge light type backlight unit, the backlight unit may include a flexible light guide plate formed of the aforesaid light transmissive material. When the backlight unit is a direct light type backlight unit, the backlight unit may include light sources arranged on a flexible substrate. Also, when the magnetic display panel according to the present invention is applied to a paper like flexible display, a glow material may be used as a light source instead of the backlight unit. For example, a glow material, such as copper-activated zinc sulfide (ZnS:Cu) or copper and magnesium activated zinc sulfide (ZnS:Cu,Mg), may be used as a light source instead of the backlight unit.

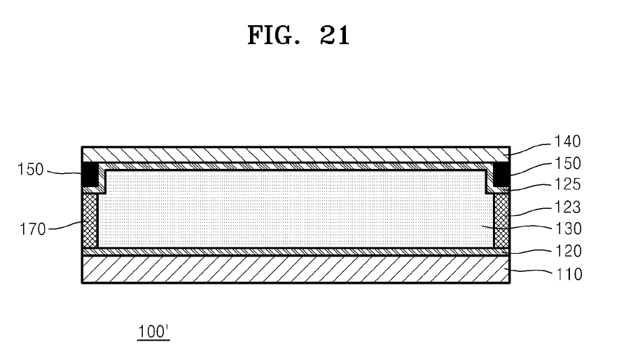

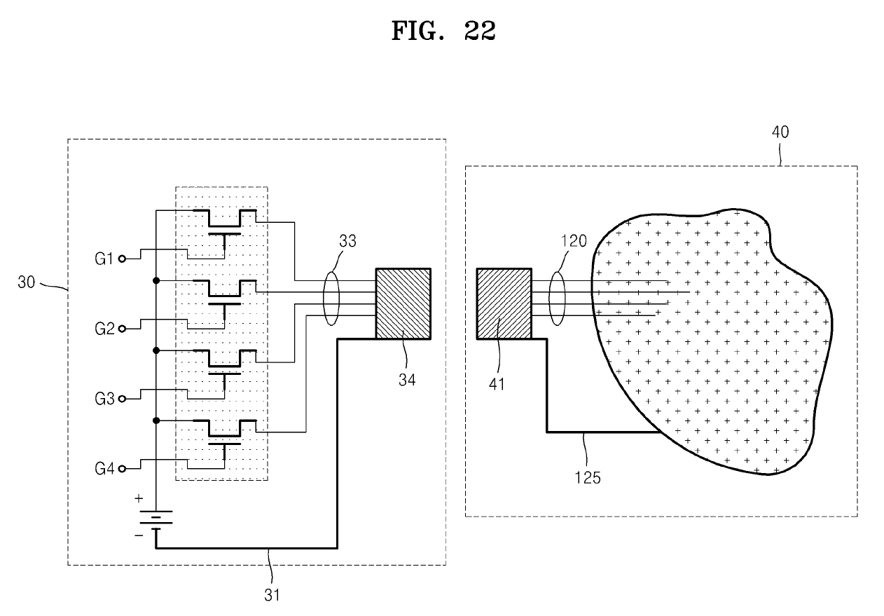

Also, even when an inorganic TFT is used instead of the organic TFT, a flexible display can be realized. Since the inorganic TFT has a hard structure and requires a high temperature process, transistor parts, that is, a flexible display unit and a controller unit, are separately manufactured. FIG. 21 is a cross-sectional view illustrating the structure of a sub-pixel 100′ of a flexible magnetic display panel. The sub-pixel 100′ of the flexible magnetic display panel of FIG. 21 is different from the sub-pixel 100 of the magnetic display panel of FIG. 10 in that a control circuit 160 is removed from the sub-pixel 100′. The other elements of the sub-pixel 100′ of the flexible magnetic display panel of FIG. 21 are the same as those of the sub-pixel 100 of the magnetic display panel of FIG. 10. Also, first and second transparent substrates 110 and 140, a sub-pixel electrode 120, a common electrode 125, and so on are formed of the aforesaid flexible materials.

FIG. 22 is a conceptual view illustrating a connection structure between a controller unit 30 and a flexible display unit 40. Referring to FIG. 22, the controller unit 30 includes inorganic TFTs for driving sub-pixels. The separate flexible display unit 40 does not have a control circuit 160 such as a TFT in a sub-pixel. The controller unit 30 includes a plurality of inorganic TFTs corresponding to sub-pixels, and a first connector 34 connected to the flexible display unit 40. The first connector 34 is electrically connected to sub-pixel electrodes 33 of the controller unit 30 extending from drains of the inorganic TFTs and to a common electrode 31 of the controller unit 30 extending from sources of the inorganic TFTs. The flexible display unit 40 includes a second connector 41 coupled to the first connector 34 of the controller unit 30. The second connector 41 is electrically connected to sub-pixel electrodes 120 and a common electrode 125 of the flexible display unit 40. Accordingly, the sub-pixels in the flexible display units 40 can be controlled by the controller unit 30 to be turned on and off by coupling the first connector 34 to the second connector 41.

As described above, the color selective active polarizer according to the present invention can be more easily manufactured in a larger size at lower costs than conventional wire-grid polarizers. Also, the color selective active polarizer according to the present invention can function as a color filter as well as a reflective polarizer.

The magnetic display panel according to the present invention does not use a color filter, a front polarizer, and a rear polarizer which are indispensable for conventional LCD panels. Accordingly, since the magnetic display panel according to the present invention can transmit or reflect light with a smaller number of components, the magnetic display panel according to the present invention can be more simply manufactured at lower costs than conventional LCD panels.

Furthermore, the magnetic display panel according to the present invention can use most of conventional manufacturing processes for manufacturing conventional LCD panels.

Moreover, since the magnetic display panel according to the present invention does not require a high temperature process, the magnetic display panel can be applied to a flexible display.

Since the magnetic display panel according to the present invention can be easily manufactured to a small screen and a large screen, the magnetic display panel according to the present invention can be widely applied to various-sized electronic devices displaying images, such as televisions (TVs), personal computers (PCs), notebook computers, mobile phones, portable multimedia players (PMPs), or game consoles.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A color selective optical device comprising:
a magnetic material layer comprising:
a transparent insulating medium;
magnetic particles disposed in the transparent insulating medium; and
one of dyes and color absorbing particles,
wherein the magnetic material layer transmits light polarized in a first direction and reflects light polarized in a second direction when a magnetic field is applied, and the light polarized in the first direction and transmitted by the magnetic material layer, includes a color according to the one of the dyes and the color absorbing particles.

2. The color selective optical device of claim 1, wherein a thickness of the magnetic material layer is greater than a magnetic decay length of the magnetic material layer.

3. The color selective optical device of claim 1, wherein the magnetic particles are core-shell type magnetic particles, and the core-shell type magnetic particles and the color absorbing particles are mixed and distributed in the transparent insulating medium.

4. The color selective optical device of claim 3, wherein each of the core-shell type magnetic particles includes a magnetic core formed of a magnetic material and an insulating shell surrounding the magnetic core.

5. The color selective optical device of claim 4, wherein one magnetic core forms a single magnetic domain.

6. The color selective optical device of claim 4, wherein the magnetic material used for the magnetic core is any one selected from the group consisting of cobalt, iron, iron oxide, nickel, cobalt-platinum (Co—Pt), iron-platinum (Fe—Pt), titanium, aluminum, barium, platinum, sodium, strontium, magnesium, dysprosium, manganese, gadolinium, silver, copper, and chromium, or an alloy comprising at least two materials of the group.

7. The color selective optical device of claim 3, wherein each of the color absorbing particles includes a core formed of a dielectric material and a shell formed of a metal.

8. The color selective optical device of claim 1, further comprising a magnetic field applying unit which applies a magnetic field to the magnetic material layer, wherein the magnetic field applying unit includes a plurality of wires disposed parallel to one another around the magnetic material layer and a power source which supplies current to the plurality of wires.

9. The color selective optical device of claim 1, further comprising a magnetic field applying unit which applies a magnetic field to the magnetic material layer,
wherein the magnetic field applying unit includes a transparent plate electrode disposed on a surface of the magnetic material layer and a power source which supplies current to the transparent plate electrode.

10. A display pixel comprising:
a magnetic material layer which transmits light or does not transmit light depending on whether a magnetic field is applied;
a first electrode disposed at a first surface of the magnetic material layer;
a second electrode disposed at a second surface of the magnetic material layer; and
a conductor disposed on a third surface of the magnetic material layer, electrically connecting the first electrode and the second electrode,
wherein one of dyes and color absorbing particles are disposed in the magnetic material layer and the light transmitted by the magnetic material layer includes a color according to the one of the dyes and the color absorbing particles.

11. The display pixel of claim 10, wherein the magnetic material layer transmits light polarized in a first direction and reflects light polarized in a second direction perpendicular to the first direction when the magnetic field is applied, and reflects all light when no magnetic field is applied.

12. The display pixel of claim 10, wherein the magnetic material layer comprises a transparent insulating medium and magnetic particles disposed in the transparent insulating medium without aggregation.

13. The display pixel of claim 12, wherein a thickness of the magnetic material layer is greater than a magnetic decay length of the magnetic material layer.

14. The display pixel of claim 12, wherein the magnetic particles are core-shell type magnetic particles, and the core-shell type magnetic particles and the color absorbing particles are mixed and distributed in the transparent insulating medium.

15. The display pixel of claim 14, wherein each of the core-shell type magnetic particles includes a magnetic core formed of a magnetic material and an insulating shell surrounding the magnetic core.

16. The display pixel of claim 15, wherein one magnetic core forms a single magnetic domain.

17. The display pixel of claim 14, wherein each of the color absorbing particles includes a core formed of a dielectric material and a shell formed of a metal.

18. The display pixel of claim 10, further comprising a first transparent substrate on which the first electrode is disposed and a second transparent substrate on which the second electrode is disposed.

19. The display pixel of claim 18, further comprising anti-reflection coating formed at least one of surfaces between the magnetic material layer a surface of the second transparent substrate.

20. The display pixel of claim 18, further comprising an absorptive polarizer disposed at one of surfaces between the magnetic material layer and a surface of the second transparent substrate.

21. The display pixel of claim 18, further comprising one of a mirror and a semi-transmissive mirror disposed at least one of surfaces between the magnetic material layer and a surface of the first transparent substrate.

22. The display pixel of claim 10, wherein the second electrode is of a mesh type or a grid wire type electrically connected to the conductive spacer.

23. The display pixel of claim 10, further comprising a control circuit disposed at a fourth surface of the magnetic material layer and which controls a flow of current between the first electrode and the second electrode.

24. A display panel comprising a plurality of display pixels according to claim 10.

25. The display panel of claim 24, further comprising a display unit in which the plurality of display pixels are disposed, and a controller unit which individually controls the flow of current between the first electrode and the second electrode for each of the plurality of display pixels.
